(19) United States
(12) Patent Application Publication
(10) Pub. No.: US 2014/0045739 A1
(43) Pub. Date: Feb. 13, 2014

(54) DETERGENT COMPOSITION

(71) Applicant: THE PROCTER & GAMBLE COMPANY, CINCINNATI, OH (US)

(72) Inventors: Jose David BAEZ CHAVEZ, Newcastle upon Tyne (GB); Mohammed Badrulhisham BAHARI, Singapore (SG)

(73) Assignee: THE PROCTER & GAMBLE COMPANY, Cincinnati, OH (US)

(21) Appl. No.: 13/921,230

(22) Filed: Jun. 19, 2013

Related U.S. Application Data
(63) Continuation of application No. 13/034,861, filed on Feb. 25, 2011, now abandoned.

(30) Foreign Application Priority Data
Feb. 25, 2010 (EP) 10154742.2

(51) Int. Cl. C11D 7/46

(52) U.S. Cl. CPC C11D 7/46
USPC 510/226

(57) ABSTRACT

A phosphate-free automatic dishwashing detergent composition comprising:
a) a coated bleach particle comprising a core substantially consisting of bleach and a coating layer enclosing this core and adhering thereto substantially consisting of sodium sulphate; and
b) a protease, amylase or a mixture thereof.
   wherein the composition is preferably free of anionic and/or cationic surfactants.

### TECHNICAL FIELD

The present invention is in the field of detergent, especially in the field of automatic dishwashing detergent. More specifically, the invention is in the field of phosphate free automatic dishwashing compositions comprising coated bleach and enzymes.

### BACKGROUND OF THE INVENTION

Traditionally phosphate builders have been used in detergent formulations. Environmental considerations make desirable the replacement of phosphate by more environmentally friendly builders. Apart from cleaning repercussions the replacement of phosphate can impair the stability of the detergent. Phosphate is a good moisture sink contributing to moisture management and stability of the detergent. The majority of the builders which can be used as replacement for phosphate are incapable of acting as moisture sink furthermore they are usually hygroscopic, contributing to the instability and degradation of the detergent, this has a greater impact in detergents which comprise moisture sensitive ingredients such as bleach and enzymes.

It has been found that the stability of enzymes in nil-P detergents is very poor. There is a need to improve this stability, thus, the objective of the present invention is to provide a detergent composition, free of phosphate with good storage stability.

### SUMMARY OF THE INVENTION

According to a first aspect of the invention there is provided a phosphate free automatic dishwashing detergent composition. The composition comprises a specific coated bleach particle and an enzyme selected from the group of: amylase, protease and mixtures thereof. The composition of the invention presents good enzyme stability, even under high temperature and humidity conditions. Enzymes are usually present in detergent formulations in the form of granulates. Granulates contribute to the stability of the enzyme, usually efflorescent materials are part of the granulates to provide stability. Even although granulates contribute to enzyme stability they do not completely solve the problem, especially in very stressed detergent matrices such as phosphate free detergents. Granulates with low level of efflorescent material are more prone to instability issues than those with high level.

Preferably, the protease and amylase of the composition of the invention are in the form of granulates, the granulates comprise less than 29% of efflorescent material by weight of the granulate or the efflorescent material and the active enzyme (protease and/or amylase) are in a weight ratio of less than 4:1.

The coated bleach particle of the composition of the invention consists of a core substantially consisting of bleach (preferably the bleach is sodium percarbonate) and a coating layer enclosing the core and firmly adhering thereto. The coating layer substantially consists of sodium sulphate.

By “substantially” is herein meant that at least 90%, preferably at least 95% and more preferably at least 99% by weight of the core or coating layer is bleach (preferably sodium percarbonate) or sodium sulphate, respectively. The bleach particle of the composition of the invention can have more than one coating layer but preferably it has only one coating layer.

Preferably, the composition of the invention is free of anionic and cationic surfactants. These types of surfactants can suds too much during the automatic dishwashing process. Suds in an automatic dishwashing process are best avoided or kept to a minimum otherwise they would slow down or even bring to a halt the rotor of the dishwashing machine.

It is not well understood how and why the bleach particle contributes to the stability of the enzyme in a phosphate free detergent matrix. It could possibly be due to the structure of the particle. The structure of the particle can be in part determined by the process of manufacture. In a preferred embodiment the core of the particle of the composition of the invention is produced by fluidised bed spray granulation and the coating layer is obtainable (preferably obtained) by spraying an aqueous sodium sulphate solution onto the core in the fluidised bed. Preferably the water of the aqueous solution is evaporated while preferably maintaining a fluidised bed temperature of from about 35 to about 100° C. A particle obtainable and preferably obtained according to this process greatly contributes to the enzyme stability in the composition of the invention.

The bleach particle of the invention does not need a thick coating in order to provide the previously alluded benefits. Preferably the coating of the particle is from 5 to 10%, more preferably from 6 to 8% by weight of the particle.

In a preferred embodiment, the composition of the invention comprises a protease, the protease demonstrates at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN′ numbering system and amino acid abbreviations as illustrated in WO00/37627: 68, 87, 99, 101, 103, 104, 118, 128, 129, 130, 167, 170, 194, 205 & 222 and optionally one or more insertions in the region comprising amino acids 95-103. Preferably, the mutations are selected from one or more, preferably two or more and more preferably three or more of the following: V68A, N87S, S99D, S99SD, S99A, S101G, S103A, V104N/I, Y167A, R1705, A194P, V2051 and/or M222S. The protease is more stable with the bleach particle of the invention than with other known coated bleach particles.

In a preferred embodiment, the composition of the invention comprises an amylase wherein the amylase is selected from the group comprising:

a) an amylase exhibiting at least 95% identity with the wild-type enzyme from Bacillus sp. 707 (SEQ ID NO:7 in U.S. Pat. No. 6,093,562), especially those comprising one or more of the following mutations M202, M208, 5255, R172, and/or M261, preferably said amylase comprises one or more of M202L, M202V, M2025, M202T, M202I, M202Q, M202W, S255N and/or R172Q. Particularly preferred are those amylases comprising the M202L or M202T mutations; and
b) an amylase exhibiting at least 95% identity with the wild-type enzyme from AA560 (SEQ ID NO. 12 in WO 06/002643), especially those comprising one or more of the following mutations 9, 26, 118, 149, 182, 186, 195, 202, 257, 295, 299, 320, 323, 339, 345 and 458 and optionally comprising one or more deletions at 183 and 184.

In especially preferred embodiments the composition comprises a mixture of the preferred protease and the preferred amylase. This composition is very good in terms of cleaning and at the same time presents good enzyme stability.

In a preferred embodiment, the composition of the invention comprises a bleach activator, preferably tetraacetylethylenediamine. The level or retention of bleach activator in the composition of the invention is higher than that found in compositions comprising a bleach particle that is not the bleach particle of the invention.

In a preferred embodiment the composition of the invention comprises a dispersant. By “dispersant” herein is meant any compound capable of dispersing (i.e. maintain suspended in the wash liquor) either metallic ions, such as calcium, iron, and any other metallic ions found in a dishwashing liquor and/or soils found in a dishwashing liquor. The dispersant helps to avoid the deposition of scale and re-deposition of soils on the washed items thereby contributing to provide lack of filming and spotting on the washed objects, resulting on improved shine.

Preferred dispersants for use herein are selected from the group of organic polymers, organic builders and mixtures thereof. In a preferred embodiment the organic polymer is a carboxylated polymer, in particular a polyacrylic acid polymer.

Preferred organic builders for use herein include MGDA, GLDA, IDS, carboxymethyl inulin, citric acid their salts and mixtures thereof. These organic builders have good dispersant properties and at the same time present a good environmental profile. The dispersant properties contribute to good cleaning and finishing.

According to a second aspect of the invention, there is provided a unit dose product (i.e. a product sufficient for a single wash) comprising the detergent of the invention. Suitable unit dose forms include tablets, capsules, sachets, pouches, injection moulded packs etc. Especially preferred for use herein are pouches, single and multi-compartment pouches. The pouches preferably have a weight from about 15 to about 25 grams, more preferably from about 17 to about 22 grams. A specially preferred embodiment provides a unit dose product in the form of a multi-compartment pouch. Preferably the pouch comprises a compartment containing a liquid and another compartment containing a solid composition, preferably the solid composition is in powder form. Preferably the enzymes and the bleach are in solid form. The stability of enzymes in this kind of unit dose products is extremely challenging because moisture can be transferred from the liquid compartment to the solid compartment, impairing the stability of ingredients in the solid compartment. The enzymes of the composition of the invention have been found to be stable even in a solid/liquid unit dose product.

According to the last aspect of the invention, there is provided an automatic dishwashing dosing element for use in an auto-dosing device the dosing element comprising the composition of the invention. Dosing elements used in an auto-dosing device are subjected to very extreme conditions in terms of temperature and humidity. The auto-dosing device usually stays in the dishwasher for more than 10 washes and thereby is subjected to high temperature and humidity that can negatively impact the stability of the product. The composition of the invention seems to provide a benefit even under the extreme conditions to which the dosing elements of an auto-dosing device are subjected.

### DETAILED DESCRIPTION OF THE INVENTION

The present invention envisages a phosphate free automatic dishwashing detergent composition comprising a coated bleach particle (preferably the particle has a single layer coating) and an enzyme, selected from protease, amylase and/or a mixture thereof. The composition provides good cleaning and presents good enzyme stability, even under stressed conditions such as high temperature and high humidity. The invention also envisages a product in unit dose form comprising the composition of the invention.

### Bleach Particle

The coated bleach particle, preferably sodium percarbonate particle, comprises a core substantially consisting of sodium percarbonate and a coating layer enclosing this core and firmly adhering thereto substantially consisting of sodium sulphate, which may be partially hydrated. The particle is characterised in that the core consists of sodium percarbonate produced by fluidised bed spray granulation and the coating layer is obtainable, and preferably obtained, by spraying an aqueous sodium sulphate solution onto the uncoated particles of the sodium percarbonate fluidised bed spray granulate located in the fluidised bed and by evaporating water while preferably maintaining a fluidised bed temperature of 35 to 100° C.

The core of the coated sodium percarbonate particle substantially consists of sodium percarbonate, which has been produced by fluidised bed spray granulation, wherein a hydrogen peroxide solution and a soda solution are sprayed in a fluidised bed apparatus onto nuclei of sodium percarbonate or of other organic or inorganic substances and water is simultaneously vaporised. With regard to the production of the core substantially consisting of sodium percarbonate by fluidised bed spray granulation processes, reference is made by way of example to DE-OS 27 33 935 and to WO 95/06615. The term “substantially” is taken to mean that, as a result of the production process, the core may contain small quantities of auxiliary substances, i.e. substances other than sodium percarbonate. The auxiliary substances are conventionally present in a quantity of less than 10%, preferably less than 5% and in particular of less than 1% wt. %, relative to the core. The auxiliary substances are in particular active oxygen stabilisers, such as for example silicates and/or magnesium compounds. Another class of auxiliary substances comprises inorganic or organic compounds which are used as nuclei in fluidised bed spray granulation for the production of sodium percarbonate, for example soda and other substances as are already used in conventional automatic dishwashing detergents.

The coating layer substantially consists of sodium sulphate, which may be partially hydrated. The coating layer is preferably produced by means of a fluidised bed spray granulation process. Preferably, there is only one coating layer.

As is known, sodium sulphate forms various hydrates, in particular the decahydrate. So that a good stabilising action may be achieved, endeavours are made during production to obtain a product having the lowest possible degree of hydration. For this reason, the fluidised bed temperature during application of the coating layer is maintained above the transition temperature of the decahydrate (32.4° C.). The weight of the single-layer coating on the core substantially consisting of sodium sulphate is usually between 0.5 and 25 wt. %, calculated without hydrate, relative to the sodium percarbonate. The entire quantity of coating preferably amounts to 1 to 15% by weight in particular 2 to 10% by weight, in each case calculated without hydrate and relative to sodium percarbonate.

A feature of the coated sodium percarbonate particles according to the invention is that the coating layer is obtainable, preferably obtained, according to the process described herein before. The selection of the material (s) in the outermost layer of the coating has a substantial influence on active oxygen stability and caking behaviour and consequently on ensilability.

WO 97/19890 teaches that very good active oxygen stability accompanied by excellent ensilability may be achieved by using a core of sodium percarbonate fluidised bed spray granulate and sodium sulphate as the sole constituent of the coating layer. While, for example, coated sodium percarbonate particles having soda in the outermost layer of the coating tend to cake during storage, this caking may be avoided if the outermost layer of the coating consists of sodium sulphate, which may be partially hydrated. The good stability of the bleach particle contributes to the good stability of the enzyme in the composition of the invention.

As already mentioned, the bleach particles coated according to the invention may be produced by coating in the fluidised bed. The process for applying a coating onto sodium percarbonate by spraying an aqueous solution containing a coating component on uncoated sodium percarbonate particles located in a fluidised bed is known per se, reference is made by way of example to EP-A 0 623 553, WO 95/02555, U.S. Pat. No. 4,325,933 and DE-PS 26 22 610, in which the process for fluidised bed coating is thoroughly described. A fluidised bed is formed using air as the fluidisation and drying gas and uncoated sodium percarbonate according to the invention. The Na2S04 solution to be sprayed preferably has a sodium sulphate content of between 10 and 30 wt. %. This solution is sprayed by means of one or more spray nozzles onto the particles in the fluidised bed. Spraying preferably proceeds at a fluidised bed temperature of 50 to 80° C.

The air used for fluidisation and drying conventionally has a temperature of between 50 and 200° C., in particular from 80 to 120° C. The coating layer may be applied in conventional apparatuses for fluidised bed spray granulation, for example in substantially round fluidised bed apparatuses or in a flow channel. During or after application of the outermost layer of the coating, the material located in the fluidised bed or discharged therefrom may be subjected to a conventional classification process. The average grain diameter and the grain size range of the particles to be coated is selected in such a manner that the coated product according to the invention satisfies applicational requirements (a coarse material is often preferred with regard to elevated oxygen stability, while a finer material is preferred with regard to a short dissolution time).

Preferably the bleach particle in the composition of the invention have a weight geometric mean particle size of from about 400 μm to about 1200 μm, more preferably from about 500 μm to about 1000 μm and especially from about 700 μm to about 900 μm. Preferably the bleach particle has a low level of fines and coarse particles, in particular less than 10% by weight of the bleach are above about 1400, more preferably about 1200 or below about 400, more preferably about 200 μm. These mean particle size and particle size distribution further contribute to the stability of the composition. In especially preferred embodiments, from the stability point of view, the bleach has a weight geometric mean particle size of from about 700 to about 1000 μm with less than about 3% by weight of the bleach above about 1180 μm and less than about 5% by weight of the bleach below about 200 μm. The weight geometric mean particle size can be measured using a Malvern particle size analyser based on laser diffraction.

Preferably the composition of the invention comprises from about 3 to about 30%, more preferably from about 5 to about 20% and especially from about 7 to about 15% of bleach particle by weight of the composition.

### Cleaning Actives

Any cleaning ingredient can be used as part of the product of the invention. The levels given are weight percent and refer to the total composition (excluding the enveloping water-soluble material, in the case of unit dose products having a wrapper or enveloping material). The composition is free of phosphate builder and in addition to the bleach and enzyme comprises one or more detergent active components which may be selected from surfactants, bleach activator, bleach catalyst, alkalinity sources, dispersants, anti-corrosion agents and care agents. Highly preferred cleaning components for use herein include a surfactant, a builder, a dispersant and a care agent.

### Surfactant

Surfactants suitable for use herein include non-ionic surfactants. Traditionally, non-ionic surfactants have been used in automatic dishwashing for surface modification purposes in particular for sheeting to avoid filming and spotting and to improve shine. It has been found that non-ionic surfactants can also contribute to prevent redeposition of soils.

Preferably the composition of the invention comprises a non-ionic surfactant or a non-ionic surfactant system, more preferably the non-ionic surfactant or a non-ionic surfactant system has a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and finishing properties and better stability in product than single non-ionic surfactants.

Phase inversion temperature is the temperature below which a surfactant, or a mixture thereof, partitions preferentially into the water phase as oil-swollen micelles and above which it partitions preferentially into the oil phase as water swollen inverted micelles. Phase inversion temperature can be determined visually by identifying at which temperature cloudiness occurs.

The phase inversion temperature of a non-ionic surfactant or system can be determined as follows: a solution containing 1% of the corresponding surfactant or mixture by weight of the solution in distilled water is prepared. The solution is stirred gently before phase inversion temperature analysis to ensure that the process occurs in chemical equilibrium. The phase inversion temperature is taken in a thermostable bath by immersing the solutions in 75 mm sealed glass test tube. To ensure the absence of leakage, the test tube is weighed before and after phase inversion temperature measurement. The temperature is gradually increased at a rate of less than 1° C. per minute, until the temperature reaches a few degrees below the pre-estimated phase inversion temperature. Phase inversion temperature is determined visually at the first sign of turbidity.

Preferred for use herein is an alcohol alkoxylated. An alcohol alkoxylated is a compound obtained by the condensation of alkylene oxide groups with an organic hydrophobic material which may be aliphatic or alkyl aromatic in nature, preferably is a compound selected from the group consisting of a C2-C18 alcohol alkoxylate having EO, PO and/or BO moieties. The moieties can be in block configuration or randomly distributed.

Preferably the alcohol alkoxylated is an alcohol ethoxylated, substantially free of other alkoxylated groups (i.e. less than 10%, more preferably less than 5% and especially less than 1% of alkoxylated groups other than ethoxy groups). Suitable herein are primary alcohols having preferably from 8 to 18 carbon atoms and on average from 1 to 12 mol of ethylene oxide (EO) per mole of alcohol in which the alcohol radical may be linear or 2-methyl-branched, or may contain a mixture of linear and methyl-branched radicals, as are typically present in oxo alcohol radicals. Preferred alcohol ethoxylated have linear radicals of alcohols of natural origin having from 12 to 18 carbon atoms, for example, of coconut, palm, tallow fat or oleyl alcohol, and on average from 2 to 8 EO per mole of alcohol. Preferred ethoxylated alcohols include, for example, C12-14-alcohols having 3 EO or 4 EO, C9-11-alcohol having 7 EO, C13-15-alcohols having 3 EO, 5 EO, 7 EO or 8 EO, C12-18-alcohols having 3 EO, 5 EO or 7 EO and mixtures thereof, such as mixtures of C12-14-alcohol having 3 EO and C12-18-alcohol having 5 EO. The degrees of ethoxylation specified are statistical average values which may be an integer or a fraction for a specific product. Preferred alcohol ethoxylates have a narrowed homolog distribution (narrow range ethoxylates, NRE). In addition to these surfactants, it is also possible to use fatty alcohols having more than 12 EO. Examples thereof are tallow fatty alcohol having 14 EO, 25 EO, 30 EO or 40 EO.

Particularly preferred are the condensation products of alcohols having an alkyl group containing from about 8 to about 14 carbon atoms with an average of from about 6 to about 8 moles of ethylene oxide per mole of alcohol. Preferably at least 25%, more preferably at least 75% of the surfactant is a straight-chain ethoxylated primary alcohol. It is also preferred that the HLB (hydrophilic-lipophilic balance) of the alcohol alkoxylated be less than about 18, preferably less than about 15 and even more less than 14. Commercially available products for use herein include Lutensol®TO series, C13 oxo alcohol ethoxylated, supplied by BASF, especially suitable for use herein being Lutensol®TO7.

Other suitable alcohol ethoxylated surfactants for use herein are C2-C18 alcohol alkoxylated having EO, PO and/or BO moieties having either random or block distribution. Especially preferred for use herein is a surfactant system comprising an ethoxylated alcohol, preferably a C10-C16 alcohol having from 4 to 10 ethoxy groups. Preferably, the alkoxylated alcohol is in a level of from about 0.1% to about 20%, preferably from about 1% to about 10% and more preferably from about 4% to about 8% by weight of the detergent composition.

Other suitable alkoxylated alcohols for use herein include a C2-C18 alcohol alkoxylate having EO, PO and/or BO moieties, specially a C2-C18 alcohol comprising EO and BO moieties in a random configuration. Particularly preferred are the following fatty alcohol alkoxylates such as Adekanol B2020 (Adeka), Dehypon LS36 (Cognis), Plurafac LF 221 (C13-15, EO/BO (95%)), Plurafac LF 300, Plurafac LF 303 (EO/PO), Plurafac LF 1300, Plurafac LF224, Degressal SD 20 (polypropoxylate) (all from BASF), Surfonic LF 17 (C12-18 ethoxylated propoxylated alcohol, Huntsman), Triton EF 24 (Dow), Neodol ethoxylates from Shell.

Also suitable for use herein are polyoxyalkene condensates of aliphatic carboxylic acids, whether linear- or branched-chain and unsaturated or saturated, especially ethoxylated and/or propoxylated aliphatic acids containing from about 8 to about 18 carbon atoms in the aliphatic chain and incorporating from about 2 to about 50 ethylene oxide and/or propylene oxide units. Suitable carboxylic acids include coconut” fatty acids (derived from coconut oil) which contain an average of about 12 carbon atoms, “tallow” fatty acids (derived from tallow-class fats) which contain an average of about 18 carbon atoms, palmitic acid, myristic acid, stearic acid and lauric acid.

Also suitable for use herein are polyoxyalkene condensates of aliphatic alcohols, whether linear- or branched-chain and unsaturated or saturated, especially ethoxylated and/or propoxylated aliphatic alcohols containing from about 6 to about 24 carbon atoms and incorporating from about 2 to about 50 ethylene oxide and/or propylene oxide units. Suitable alcohols include “coconut” fatty alcohol, “tallow” fatty alcohol, lauryl alcohol, myristyl alcohol and oleyl alcohol. Other example types of nonionic surfactants are linear fatty alcohol alkoxylates with a capped terminal group, as described in U.S. Pat. No. 4,340,766 to BASF.

Other example type includes olyoxyethylene-polyoxypropylene block copolymers haying formula:

HO(CH2CH2O)a(CH(CH3)CH2O)b(CH2CH2O)cH;

or

HO(CH(CH3)CH2O)d(CH2CH2O)e(CH(CH3)CH2O)H

wherein a, b, c, d, e and f are integers from 1 to 350 reflecting the respective polyethylene oxide and polypropylene oxide blocks of said polymer. The polyoxyethylene component of the block polymer constitutes at least about 10% of the block polymer. The material can for instance have a molecular weight of between about 1,000 and about 15,000, more specifically from about 1,500 to about 6,000. These materials are well-known in the art. They are available under the trademark “Pluronic” and “Pluronic R”, from BASF Corporation.

Suitable nonionic surfactants include: i) ethoxylated non-ionic surfactants prepared by the reaction of a monohydroxy alkanol or alkyphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii).

Another suitable non-ionic surfactants are epoxy-capped poly(oxyalkylated) alcohols represented by the formula:

R1O[CH2CH(CH3)O]x[CH2CH2O]y[CH2CH(OH)R2] (I)

wherein R1 is a linear or branched, aliphatic hydrocarbon radical having from 4 to 18 carbon atoms; R2 is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20.

Preferably, the surfactant of formula I, at least about 10 carbon atoms in the terminal epoxide unit [CH2CH(OH)R2]. Suitable surfactants of formula I, according to the present invention, are Olin Corporation's POLY-TERGENT® SLF-18B nonionic surfactants, as described, for example, in WO 94/22800, published Oct. 13, 1994 by Olin Corporation.

Preferably non-ionic surfactants and/or system to use as anti-redeposition agents herein have a Draves wetting time of less than 360 seconds, preferably less than 200 seconds, more preferably less than 100 seconds and especially less than 60 seconds as measured by the Draves wetting method (standard method ISO 8022 using the following conditions; 3-g hook, 5-g cotton skein, 0.1% by weight aqueous solution at a temperature of 25° C.).

Amine oxides surfactants are also useful in the present invention as anti-redeposition surfactants include linear and branched compounds having the formula:

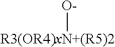

wherein R3 is selected from an alkyl, hydroxyalkyl, acylamidopropoyl and alkyl phenyl group, or mixtures thereof, containing from 8 to 26 carbon atoms, preferably 8 to 18 carbon atoms; R4 is an alkylene or hydroxyalkylene group containing from 2 to 3 carbon atoms, preferably 2 carbon atoms, or mixtures thereof; x is from 0 to 5, preferably from 0 to 3; and each R5 is an alkyl or hydroxyalkyl group containing from 1 to 3, preferably from 1 to 2 carbon atoms, or a polyethylene oxide group containing from 1 to 3, preferable 1, ethylene oxide groups. The R5 groups can be attached to each other, e.g., through an oxygen or nitrogen atom, to form a ring structure.

These amine oxide surfactants in particular include C10-C18 alkyl dimethyl amine oxides and C8-C18 alkoxy ethyl dihydroxyethyl amine oxides. Examples of such materials include dimethyloctylamine oxide, diethyldecylamine oxide, bis-(2-hydroxyethyl)dodecylamine oxide, dimethyldodecylamine oxide, dipropyltetradecylamine oxide, methylethylhexadecylamine oxide, dodecylamidopropyl dimethylamine oxide, cetyl dimethylamine oxide, stearyl dimethylamine oxide, tallow dimethylamine oxide and dimethyl-2-hydroxyoctadecylamine oxide. Preferred are C10-C18 alkyl dimethylamine oxide, and C10-18 acylamido alkyl dimethylamine oxide.

Surfactants may be present in amounts from 0 to 10% by weight, preferably from 0.1% to 10%, and most preferably from 0.25% to 6% by weight of the total composition.

### Builder

Builders for use herein include inorganic builders and organic builders. If present, builders are used in a level of from 5 to 60%, more preferably from 10 to 50% by weight of the composition. In some embodiments the product comprises a mixture of inorganic and organic builders.

### Inorganic Builders

Preferred inorganic builders include carbonates, in particular sodium carbonate.

### Organic Builders

Preferred organic builders include amino acid based compounds, in particular MGDA (methyl-glycine-diacetic acid), GLDA (glutamic-N,N-diacetic acid), iminodisuccinic acid (IDS), carboxymethyl inulin and salts and derivatives thereof. Preferably MGDA or GLDA are present in the composition of the invention in a level of from 0.5% to 50%, more preferably from about 1% to about 20% and especially from about 2 to about 10% by weight of the composition. MGDA (salts and derivatives thereof) is especially preferred according to the invention, with the tetrasodium salt thereof being especially preferred.

Other suitable organic builders include amino acid based compound or a succinate based compound. The term “succinate based compound” and “succinic acid based compound” are used interchangeably herein. Other suitable builders are described in U.S. Pat. No. 6,426,229. Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)aspartic acid (SMAS), N-(2-sulfoethyl)aspartic acid (SEAS), N-(2-sulfomethyl)glutamic acid (SMGL), N-(2-sulfoethyl)glutamic acid (SEGL), IDS (iminodiacetic acid) and salts and derivatives thereof such as N-methyliminodiacetic acid (MIDA), alpha-alanine-N,N-diacetic acid (alpha-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA) and alkali metal salts or ammonium salts thereof.

Carboxymethyl inulin is also a non-phosphate builder suitable for use herein. Carboxymethyl inulin is a carboxyl-containing fructan where the carboxyl is carboxymethyl and the fructan has β-2,1 bond. The carboxymethyl inulin is typically supplied as an alkali metal salt such as sodium carboxymethyl inulin. A suitable source of the carboxymethyl inulin is Dequest SPE 15625 from Thermphos International. The carboxymethyl inulin may have a degree of substitution ranging from about 1.5 to about 3, and may in some embodiments be about 2.5.

Preferably the organic builder is present in the composition in an amount of at least 1%, more preferably at least 5%, even more preferably at least 10%, and most especially at least 20% by weight of the total composition. Preferably these builders are present in an amount of up to 50%, more preferably up to 45%, even more preferably up to 40%, and especially up to 35% by weight of the total composition. In preferred embodiments the composition contains 20% by weight of the total composition or less of phosphate builders, more preferably 10% by weight of the total composition or less, most preferably they are substantially free of phosphate builders.

Other organic builders include polycarboxylic acids. Suitable polycarboxylic acids are acyclic, alicyclic, heterocyclic and aromatic carboxylic acids, in which case they contain at least two carboxyl groups which are in each case separated from one another by, preferably, no more than two carbon atoms. Polycarboxylates which comprise two carboxyl groups include, for example, water-soluble salts of, malonic acid, (ethyl enedioxy)diacetic acid, maleic acid, diglycolic acid, tartaric acid, tartronic acid and fumaric acid. Polycarboxylates which contain three carboxyl groups include, for example, water-soluble citrate. Correspondingly, a suitable hydroxycarboxylic acid is, for example, citric acid. Other suitable builders are disclosed in WO 95/01416, to the contents of which express reference is hereby made.

### Organic Polymer

The polymer, if present, is used in any suitable amount from about 0.1% to about 50%, preferably from 0.5% to about 20%, more preferably from 1% to 10% by weight of the composition.

Preferred organic polymers herein include acrylic acid containing polymers such as Sokalan PA30, PA20, PAIS, PA10 and Sokalan CP10 (BASF GmbH), Acusol 45N, 480N, 460N (Rohm and Haas), acrylic acid/maleic acid copolymers such as Sokalan CP5 and acrylic/methacrylic copolymers. Preferred soil release polymers herein include alkyl and hydroxyalkyl celluloses (U.S. Pat. No. 4,000,093), polyoxyethylenes, polyoxypropylenes and copolymers thereof, and nonionic and anionic polymers based on terephthalate esters of ethylene glycol, propylene glycol and mixtures thereof.

Sulfonated/carboxylated polymers are particularly suitable for the composition of the invention.

Suitable sulfonated/carboxylated polymers described herein may have a weight average molecular weight of less than or equal to about 100,000 Da, or less than or equal to about 75,000 Da, or less than or equal to about 50,000 Da, or from about 3,000 Da to about 50,000, preferably from about 5,000 Da to about 45,000 Da.

As noted herein, the sulfonated/carboxylated polymers may comprise (a) at least one structural unit derived from at least one carboxylic acid monomer having the general formula (I):

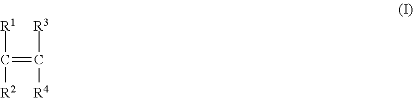

wherein R1 to R4 are independently hydrogen, methyl, carboxylic acid group or CH2COOH and wherein the carboxylic acid groups can be neutralized; (b) optionally, one or more structural units derived from at least one nonionic monomer having the general formula (II):

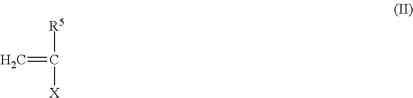

wherein R5 is hydrogen, C1 to C6 alkyl, or C1 to C6 hydroxyalkyl, and X is either aromatic (with R5 being hydrogen or methyl when X is aromatic) or X is of the general formula (III):

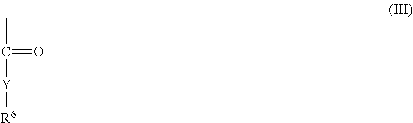

wherein R6 is (independently of R5) hydrogen, C1 to C6 alkyl, or C1 to C6 hydroxyalkyl, and Y is O or N; and at least one structural unit derived from at least one sulfonic acid monomer having the general formula (IV):

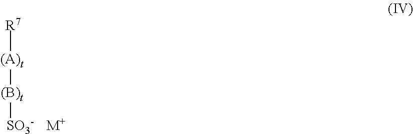

wherein R7 is a group comprising at least one sp2 bond, A is O, N, P, S or an amido or ester linkage, B is a mono- or polycyclic aromatic group or an aliphatic group, each t is independently 0 or 1, and M+ is a cation. In one aspect, R7 is a C2 to C6 alkene. In another aspect, R7 is ethene, butene or propene.

Preferred carboxylic acid monomers include one or more of the following: acrylic acid, maleic acid, itaconic acid, methacrylic acid, or ethoxylate esters of acrylic acids, acrylic and methacrylic acids being more preferred. Preferred sulfonated monomers include one or more of the following: sodium(meth)allyl sulfonate, vinyl sulfonate, sodium phenyl(meth)allyl ether sulfonate, or 2-acrylamido-methyl propane sulfonic acid. Preferred non-ionic monomers include one or more of the following: methyl (meth)acrylate, ethyl (meth)acrylate, t-butyl (meth)acrylate, methyl (meth)acrylamide, ethyl (meth)acrylamide, t-butyl (meth)acrylamide, styrene, or α-methyl styrene.

Preferably, the polymer comprises the following levels of monomers: from about 40 to about 90%, preferably from about 60 to about 90% by weight of the polymer of one or more carboxylic acid monomer; from about 5 to about 50%, preferably from about 10 to about 40% by weight of the polymer of one or more sulfonic acid monomer; and optionally from about 1% to about 30%, preferably from about 2 to about 20% by weight of the polymer of one or more non-ionic monomer. An especially preferred polymer comprises about 70% to about 80% by weight of the polymer of at least one carboxylic acid monomer and from about 20% to about 30% by weight of the polymer of at least one sulfonic acid monomer.

The carboxylic acid is preferably (meth)acrylic acid. The sulfonic acid monomer is preferably one of the following: 2-acrylamido methyl-1-propanesulfonic acid, 2-methacrylamido-2-methyl-1-propanesulfonic acid, 3-methacrylamido-2-hydroxypropanesulfonic acid, allysulfonic acid, methallysulfonic acid, allyloxybenzenesulfonic acid, methallyloxybenzensulfonic acid, 2-hydroxy-3-(2-propenyloxy)propanesulfonic acid, 2-methyl-2-propene-1-sulfonic acid, styrene sulfonic acid, vinylsulfonic acid, 3-sulfopropyl acrylate, 3-sulfopropyl methacrylate, sulfomethylacrylamid, sulfomethylmethacrylamide, and water soluble salts thereof. The unsaturated sulfonic acid monomer is most preferably 2-acrylamido-2-propanesulfonic acid (AMPS).

Preferred commercial available polymers include: Alcosperse 240, Aquatreat AR 540 and Aquatreat MPS supplied by Alco Chemical; Acumer 3100, Acumer 2000, Acusol 587G and Acusol 588G supplied by Rohm & Haas; Goodrich K-798, K-775 and K-797 supplied by BF Goodrich; and ACP 1042 supplied by ISP technologies Inc. Particularly preferred polymers are Acusol 587G and Acusol 588G supplied by Rohm & Haas.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions.

Other suitable organic polymer for use herein includes a polymer comprising an acrylic acid backbone and alkoxylated side chains, said polymer having a molecular weight of from about 2,000 to about 20,000, and said polymer having from about 20 wt % to about 50 wt % of an alkylene oxide. The polymer should have a molecular weight of from about 2,000 to about 20,000, or from about 3,000 to about 15,000, or from about 5,000 to about 13,000. The alkylene oxide (AO) component of the polymer is generally propylene oxide (PO) or ethylene oxide (EO) and generally comprises from about 20 wt % to about 50 wt %, or from about 30 wt % to about 45 wt %, or from about 30 wt % to about 40 wt % of the polymer. The alkoxylated side chains of the water soluble polymers may comprise from about 10 to about 55 AO units, or from about 20 to about 50 AO units, or from about 25 to 50 AO units. The polymers, preferably water soluble, may be configured as random, block, graft, or other known configurations. Methods for forming alkoxylated acrylic acid polymers are disclosed in U.S. Pat. No. 3,880,765.

Other suitable organic polymer for use herein includes polyaspartic acid (PAS) derivatives as described in WO 2009/095645 A1.

### Silicates

Preferred silicates are sodium silicates such as sodium disilicate, sodium metasilicate and crystalline phyllosilicates. Silicates if present are at a level of from about 1 to about 20%, preferably from about 5 to about 15% by weight of composition.

### Additional Bleach

In addition to the bleach particle essential for the composition of the invention, the composition can also comprises other types of bleach, such as an organic bleach.

Typical organic bleaches are organic peroxyacids including diacyl and tetraacylperoxides, especially diperoxydodecanedioc acid, diperoxytetradecanedioc acid, and diperoxyhexadecanedioc acid. Dibenzoyl peroxide is a preferred organic peroxyacid herein. Mono- and diperazelaic acid, mono- and diperbrassylic acid, and Nphthaloylaminoperoxicaproic acid are also suitable herein.

The diacyl peroxide, especially dibenzoyl peroxide, should preferably be present in the form of particles having a weight average diameter of from about 0.1 to about 100 microns, preferably from about 0.5 to about 30 microns, more preferably from about 1 to about 10 microns. Preferably, at least about 25%, more preferably at least about 50%, even more preferably at least about 75%, most preferably at least about 90%, of the particles are smaller than 10 microns, preferably smaller than 6 microns. Diacyl peroxides within the above particle size range have also been found to provide better stain removal especially from plastic dishware, while minimizing undesirable deposition and filming during use in automatic dishwashing machines, than larger diacyl peroxide particles. The preferred diacyl peroxide particle size thus allows the formulator to obtain good stain removal with a low level of diacyl peroxide, which reduces deposition and filming. Conversely, as diacyl peroxide particle size increases, more diacyl peroxide is needed for good stain removal, which increases deposition on surfaces encountered during the dishwashing process.

Further typical organic bleaches include the peroxy acids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, E-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

### Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). Bleach activators if included in the compositions of the invention are in a level of from about 0.1 to about 10%, preferably from about 0.5 to about 2% by weight of the total composition.

### Bleach Catalyst

Bleach catalysts preferred for use herein include a manganese complex, e.g. Mn-Me TACN, as described in EP 458 397 A; Co, Cu, Mn and Fe bispyridylamine and related complexes (US-A-5114611); and pentamine acetate cobalt(III) and related complexes (U.S. Pat. No. 4,810,410). A complete description of bleach catalysts suitable for use herein can be found in WO 99/06521, pages 34, line 26 to page 40, line 16. The preferred bleach catalyst for use herein is a manganese complex, e.g. Mn-Me TACN, as described in EP 458 397 A. This may be present in the form of an encapsulated separately from the bleach granule. Bleach catalyst if included in the compositions of the invention are in a level of from about 0.0001 to about 2%, preferably from about 0.001 to about 1% by weight of the total composition.

### Enzyme

### Enzyme Related Terminology

### Nomenclature for Amino Acid Modifications

In describing enzyme variants herein, the following nomenclature is used for ease of reference: Original amino acid(s):position(s):substituted amino acid(s).

According to this nomenclature, for instance the substitution of glutamic acid for glycine in position 195 is shown as G195E. A deletion of glycine in the same position is shown as G195*, and insertion of an additional amino acid residue such as lysine is shown as G195GK. Where a specific enzyme contains a “deletion” in comparison with other enzyme and an insertion is made in such a position this is indicated as *36D for insertion of an aspartic acid in position 36. Multiple mutations are separated by pluses, i.e.: S99G+V102N, representing mutations in positions 99 and 102 substituting serine and valine for glycine and asparagine, respectively. Where the amino acid in a position (e.g. 102) may be substituted by another amino acid selected from a group of amino acids, e.g. the group consisting of N and I, this will be indicated by V102N/I.

In all cases, the accepted IUPAC single letter or triple letter amino acid abbreviation is employed.

### Protease Amino Acid Numbering

The numbering used herein is numbering versus the so-called BPN′ numbering scheme which is commonly used in the art and is illustrated for example in WO00/37627.

### Amino Acid Identity

The relatedness between two amino acid sequences is described by the parameter “identity”. For purposes of the present invention, the alignment of two amino acid sequences is determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

The degree of identity between an amino acid sequence of and enzyme used herein (“invention sequence”) and a different amino acid sequence (“foreign sequence”) is calculated as the number of exact matches in an alignment of the two sequences, divided by the length of the “invention sequence” or the length of the “foreign sequence”, whichever is the shortest. The result is expressed in percent identity. An exact match occurs when the “invention sequence” and the “foreign sequence” have identical amino acid residues in the same positions of the overlap. The length of a sequence is the number of amino acid residues in the sequence.

Preferred enzyme for use herein includes a protease. Suitable proteases include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:

(a) subtilisins (EC 3.4.21.62), including those derived from Bacillus, such as Bacillus lentus, B. alkalophilus, B. subtilis, B. amyloliquefaciens, Bacillus pumilus and Bacillus gibsonii described in U.S. Pat. No. 6,312,936 B1, U.S. Pat. No. 5,679,630, U.S. Pat. No. 4,760,025, U.S. Pat. No. 7,262,042 and WO09/021,867.
(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.
(c) metalloproteases, including those derived from Bacillus amyloliquefaciens described in WO 07/044,993A2.

Preferred proteases include those derived from Bacillus gibsonii or Bacillus Lentus.

Especially preferred proteases for the detergent of the invention are polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN′ numbering system and amino acid abbreviations as illustrated in WO00/37627, which is incorporated herein by reference:

68, 87, 99, 101, 103, 104, 118, 128, 129, 130, 167, 170, 194, 205 & 222 and optionally one or more insertions in the region comprising amino acids 95-103.

Preferably, the mutations are selected from one or more, preferably two or more and more preferably three or more of the following: V68A, N87S, S99D, S99SD, S99A, S101G, S103A, V104N/I, Y167A, R170S, A194P, V2051 and/or M222S.

Most preferably the protease is selected from the group comprising the below mutations (BPN′ numbering system) versus either the PB92 wild-type (SEQ ID NO:2 in WO 08/010,925) or the subtilisin 309 wild-type (sequence as per PB92 backbone, except comprising a natural variation of N87S).

### (i) G118V+S128L+P129Q+S130A

### (ii) G118V+S128N+P129S+5130A+S166D

(iii) G118V+S128L+P129Q+5130A+S166D

### (iv) G118V+S128V+P129E+S130K

### (v) G118V+S128V+P129M+S166D

### (vi) G118V+S128F+P129L+S130T

(vii) G118V+S128L+P129N+5130V
(viii) G118V+S128F+P129Q

### (ix) G118V+S128V+P129E+S130K+S166D

### (x) G118V+S128R+P129S+S130P

### (xi) S128R+P129Q+S130D

(xii) S128C+P129R+5130D
(xiii) S128C+P129R+5130G
(xiv) S101G+V104N

### (xv) N76D+N87S+S103A+V104I

(xvi) V68A+N87S+S101G+V104N
(xvii) S99SD+S99A
(xviii) N87S+S99SD+S99A

Suitable commercially available protease enzymes include those sold under the trade names Alcalase®, Savinase®, Primase®, Durazym®, Polarzyme®, Kannase®, Liquanase®, Ovozyme®, Neutrase®, Everlase® and Esperase® by Novozymes A/S (Denmark), those sold under the tradename Maxatase®, Maxacal®, Maxapem®, Properase®, Purafect®, Purafect Prime®, Purafect Ox®, FN3®, FN4®, Excellase® and Purafect OXP® by Genencor International, those sold under the tradename Opticlean® and Optimase® by Solvay Enzymes, those available from Henkel/Kemira, namely BLAP (sequence shown in FIG. 29 of U.S. Pat. No. 5,352,604 with the following mutations S99D+S101 R+S103A+V104I+G159S, hereinafter referred to as BLAP), BLAP R (BLAP with S3T+V4I+V199M+V205I+L217D), BLAP X (BLAP with S3T+V4I+V2051) and BLAP F49 (BLAP with S3T+V4I+A194P+V199M+V205I+L217D)—all from Henkel/Kemira; and KAP (Bacillus alkalophilus subtilisin with mutations A230V+S256G+S259N) from Kao. Preferred for use herein in terms of performance is a dual protease system, in particular a system comprising a protease comprising S99SD+S99A mutations (BPN′ numbering system) versus either the PB92 wild-type (SEQ ID NO:2 in WO 08/010,925) or the subtilisin 309 wild-type (sequence as per PB92 backbone, except comprising a natural variation of N87S). and a DSM14391 Bacillus Gibsonii enzyme, as described in WO 2009/021867 A2.

Preferred levels of protease in the compositions of the invention include from about 0.1 to about 10, more preferably from about 0.5 to about 5 and especially from about 1 to about 4 mg of active protease per grams of composition.

Preferred enzyme for use herein includes alpha-amylases, including those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:

(a) the variants described in WO 94/02597, WO 94/18314, WO96/23874 and WO 97/43424, especially the variants with substitutions in one or more of the following positions versus the enzyme listed as SEQ ID No. 2 in WO 96/23874: 15, 23, 105, 106, 124, 128, 133, 154, 156, 181, 188, 190, 197, 202, 208, 209, 243, 264, 304, 305, 391, 408, and 444.
(b) the variants described in U.S. Pat. No. 5,856,164 and WO99/23211, WO 96/23873, WO00/60060 and WO 06/002643, especially the variants with one or more substitutions in the following positions versus the AA560 enzyme listed as SEQ ID No. 12 in WO 06/002643:
26, 30, 33, 82, 37, 106, 118, 128, 133, 149, 150, 160, 178, 182, 186, 193, 203, 214, 231, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, preferably that also contain the deletions of D183* and G184*.
(c) variants exhibiting at least 90% identity with SEQ ID No. 4 in WO06/002643, the wild-type enzyme from Bacillus SP722, especially variants with deletions in the 183 and 184 positions and variants described in WO 00/60060, which is incorporated herein by reference.
(d) variants exhibiting at least 95% identity with the wild-type enzyme from Bacillus sp. 707 (SEQ ID NO:7 in U.S. Pat. No. 6,093,562), especially those comprising one or more of the following mutations M202, M208, 5255, R172, and/or M261. Preferably said amylase comprises one or more of M202L, M202V, M2025, M202T, M202I, M202Q, M202W, S255N and/or R172Q. Particularly preferred are those comprising the M202L or M202T mutations.

Preferred α-amylases include the below variants of SEQ ID No. 12 in WO 06/002643:
(a) one or more, preferably two or more, more preferably three or more substitutions in the following positions: 9, 26, 149, 182, 186, 202, 257, 295, 299, 323, 339 and 345; and
(b) optionally with one or more, preferably four or more of the substitutions and/or deletions in the following positions: 118, 183, 184, 195, 320 and 458, which if present preferably comprise R118K, D183*, G184*, N195F, R320K and/or R458K.

Preferred amylases include those comprising the following sets of mutations:
(i) M9L+, M323T;
(ii) M9L+M202L/T/V/I+M323T;
(iii) M9L+N195F+M202L/T/V/I+M323T;
(iv) M9L+R118K+D183*+G184*+R320K+M323T+R458K;
(v) M9L+R118K+D183*+G184*+M202L/T/V/I; R320K+M323T+R458K;
(vi) M9L+G149A+G182T+G186A+M202L+T257I+Y295F+N299Y+M323T+A339S+E345R;
(vii) M9L+G149A+G182T+G186A+M202I+T257I+Y295F+N299Y+M323T+A339S+E345R;
(viii) M9L+R118K+G149A+G182T+D183*+G184*+G186A+M202L+T257I+Y295F+N299Y+R320K+M323T+A339S+E345R+R458K;
(ix) M9L+R118K+G149A+G182T+D183*+G184*+G186A+M202I+T257I+Y295F+N299Y+R320K+M323T+A339S+E345R+R458K;
(x) M9L+R118K+D183*+D184*+N195F+M202L+R320K+M323T+R458K;
(xi) M9L+R118K+D183*+D184*+N195F+M202T+R320K+M323T+R458K;
(xii) M9L+R118K+D183*+D184*+N195F+M202I+R320K+M323T+R458K;
(xiii) M9L+R118K+D183*+D184*+N195F+M202V+R320K+M323T+R458K;
(xiv) M9L+R118K+N150H+D183*+D184*+N195F+M202L+V214T+R320K+M323T+R458K; or
(xv) M9L+R118K+D183*+D184*+N195F+M202L+V214T+R320K+M323T+E345N+R458K.
(xvi) M9L+R118K+G149A+G182T+D183*+G184*+G186A+N195F+M202L+T257I+Y295F+N299Y+R320K+M323T+A339S+E345R+R458K

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, POWERASE®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS® and PURASTAR OXAM® (Genencor International Inc., Palo Alto, Calif.) and KAM® (Kao, 14-10 Nihonbashi Kayabacho, 1-chome, Chuo-ku Tokyo 103-8210, Japan). Amylases especially preferred for use herein include NATALASE®, STAINZYME®, STAINZYME PLUS®, POWERASE® and mixtures thereof.

### Additional Enzymes

Additional enzymes suitable for use in the composition of the invention can comprise one or more enzymes selected from the group comprising hemicellulases, cellulases, cellobiose dehydrogenases, peroxidases, proteases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, amylases, and mixtures thereof.

### Cellulases

The composition of the invention preferably comprises other enzymes in addition to the protease and/or amylase. Cellulase enzymes are preferred additional enzymes, particularly microbial-derived endoglucanases exhibiting endo-beta-1,4-glucanase activity (E.C. 3.2.1.4), including a bacterial polypeptide endogenous to a member of the genus Bacillus which has a sequence of at least 90%, preferably 94%, more preferably 97% and even more preferably 99% identity to the amino acid sequence SEQ ID NO:2 in U.S. Pat. No. 7,141,403B2 and mixtures thereof. Preferred commercially available cellulases for use herein are Celluzyme®, Celluclean®, Whitezyme® (Novozymes A/S) and Puradax HA® and Puradax® (Genencor International).

Preferably, the composition of the invention comprises at least 0.01 mg of active amylase per gram of composition, preferably from about 0.05 to about 10, more preferably from about 0.1 to about 6, especially from about 0.2 to about 4 mg of amylase per gram of composition.

Preferably, the protease and/or amylase of the composition of the invention are in the form of granulates, the granulates comprise less than 29% of efflorescent material by weight of the granulate or the efflorescent material and the active enzyme (protease and/or amylase) are in a weight ratio of less than 4:1.

By “efflorescent material” is herein understood a material that in its anhydrous form can take water to become hydrated and it can easily give up the hydration water when it is placed in a drier or warmer environment. Preferably the efflorescent materials for use in the composition of the invention have a difference in density between the anhydrous and hydrated form of at least 0.8 g/cm3, more preferably at least 1 g/cm3 and especially at least 1.2 g/cm3. This difference in densities provides a mechanism to break particle:particle crystal bridges that have formed as a result of water condensing as the powder temperature fell below the dew point associated with that powder. As the temperature increases following a period of cooling (as in a temperature cycle), the hydrated material forming a crystal bridge between particles reverts to the anhydrous (or less hydrated) form. The higher crystal density associated with the anhydrous (or less hydrated) form provides a mechanism for breaking these crystal bridges due to the reduction in crystal volume. This allows that a period of low temperature does not negatively and permanently affect the structure of the powder and contributes to good handling properties of the composition.

Preferred efflorescent materials for use herein include sulphate and citrates, especially preferred for use herein is sodium sulphate.

### Metal Care Agents

Metal care agents may prevent or reduce the tarnishing, corrosion or oxidation of metals, including aluminium, stainless steel and non-ferrous metals, such as silver and copper. Suitable examples include one or more of the following:

(a) benzatriazoles, including benzotriazole or bis-benzotriazole and substituted derivatives thereof. Benzotriazole derivatives are those compounds in which the available substitution sites on the aromatic ring are partially or completely substituted. Suitable substituents include linear or branch-chain C1-C20-alkyl groups and hydroxyl, thio, phenyl or halogen such as fluorine, chlorine, bromine and iodine.
(b) metal salts and complexes chosen from the group consisting of zinc, manganese, titanium, zirconium, hafnium, vanadium, cobalt, gallium and cerium salts and/or complexes, the metals being in one of the oxidation states II, III, IV, V or VI. In one aspect, suitable metal salts and/or metal complexes may be chosen from the group consisting of Mn(II) sulphate, Mn(II) citrate, Mn(II) stearate, Mn(II) acetylacetonate, K2TiF6, K2ZrF6, CoSO4, Co(NO3)₂ and Ce(NO3)₃, zinc salts, for example zinc sulphate, hydrozincite or zinc acetate;
(c) silicates, including sodium or potassium silicate, sodium disilicate, sodium metasilicate, crystalline phyllosilicate and mixtures thereof.

Further suitable organic and inorganic redox-active substances that act as silver/copper corrosion inhibitors are disclosed in WO 94/26860 and WO 94/26859.

Preferably the composition of the invention comprises from 0.1 to 5%, more preferably from 0.2 to 4% and specially from 0.3 to 3% by weight of the total composition of a metal care agent, preferably the metal care agent is a zinc salt.

### Unit Dose Form

Preferably the product of the invention is a unit-dose product. Products in unit dose form include tablets, capsules, sachets, pouches, injection moulded compartments, etc. Preferred for use herein are tablets and unit dose form wrapped with a water-soluble film (including wrapped tablets, capsules, sachets, pouches) and injection moulded containers. The unit dose form of the invention is preferably a water-soluble multi-compartment pack.

A multi-compartments pack is formed by a plurality of water-soluble enveloping materials which form a plurality of compartments, one of the compartments would contain the composition of the invention, another compartment can contain a liquid composition, the liquid composition can be aqueous (i.e. comprises more than 10% of water by weight of the liquid composition) and the compartment can be made of warm water soluble material. In some embodiments the compartment comprising the composition of the invention is made of cold water soluble material. It allows for the separation and controlled release of different ingredients. In other embodiments all the compartments are made of warm water soluble material.

Preferred packs comprise at least two side-by-side compartments superposed (i.e., placed above) onto another compartment, especially preferred are pouches. This disposition contributes to the compactness, robustness and strength of the pack, additionally, it minimise the amount of water-soluble material required. It only requires three pieces of material to form three compartments. The robustness of the pack allows also for the use of very thin films without compromising the physical integrity of the pack. The pack is also very easy to use because the compartments do not need to be folded to be used in machine dispensers of fix geometry. At least two of the compartments of the pack contain two different compositions. By “different compositions” herein is meant compositions that differ in at least one ingredient.

Preferably, at least one of the compartments contains a solid composition, preferably in powder form and another compartment an aqueous liquid composition, the compositions are preferably in a solid to liquid weight ratio of from about 20:1 to about 1:20, more preferably from about 18:1 to about 2:1 and even more preferably from about 15:1 to about 5:1. This kind of pack is very versatile because it can accommodate compositions having a broad spectrum of values of solid:liquid ratio. Particularly preferred have been found to be pouches having a high solid:liquid ratio because many of the detergent ingredients are most suitable for use in solid form, preferably in powder form. The ratio solid:liquid defined herein refers to the relationship between the weight of all the solid compositions and the weight of all the liquid compositions in the pack.

Preferably solid:liquid weight ratio is from about 2:1 to about 18:1, more preferably from about 5:1 to about 15:1. These weight ratios are suitable in cases in which most of the ingredients of the detergent are in liquid form.

Preferably the two side-by-side compartments contain liquid compositions, which can be the same but preferably are different and another compartment contains a solid composition, preferably in powder form, more preferably a densified powder. The solid composition contributes to the strength and robustness of the pack.

For dispenser fit reasons, especially in an automatic dishwasher, the unit dose form products herein have a square or rectangular base and a height of from about 1 to about 5 cm, more preferably from about 1 to about 4 cm. Preferably the weight of the solid composition is from about 5 to about 20 grams, more preferably from about 10 to about 15 grams and the weight of the liquid compositions is from about 0.5 to about 4 grams, more preferably from about 0.8 to about 3 grams.

In preferred embodiments, at least two of the films which form different compartments have different solubility, under the same conditions, releasing the content of the compositions which they partially or totally envelope at different times.

Controlled release of the ingredients of a multi-compartment pouch can be achieved by modifying the thickness of the film and/or the solubility of the film material. The solubility of the film material can be delayed by for example cross-linking the film as described in WO 02/102,955 at pages 17 and 18. Other water-soluble films designed for rinse release are described in U.S. Pat. No. 4,765,916 and U.S. Pat. No. 4,972,017. Waxy coating (see WO 95/29982) of films can help with rinse release. pH controlled release means are described in WO 04/111178, in particular amino-acetylated polysaccharide having selective degree of acetylation.

Other means of obtaining delayed release by multi-compartment pouches with different compartments, where the compartments are made of films having different solubility are taught in WO 02/08380.

### Auto-Dosing Delivery Device

The compositions of the invention are extremely useful for dosing elements to be used in an auto-dosing device. The dosing elements comprising the composition of the present invention can be placed into a delivery cartridge as that described in WO 2007/052004 and WO 2007/0833141. The dosing elements can have an elongated shape and set into an array forming a delivery cartridge which is the refill for an auto-dosing dispensing device as described in case WO 2007/051989. The delivery cartridge is to be placed in an auto-dosing delivery device, such as that described in WO 2008/053191.

All the percentages here in are by weight of the composition, unless stated otherwise.

### EXAMPLES

### Abbreviations Used in the Examples

In the examples, the abbreviated component identifications have the following meanings:

Silicate: Amorphous Sodium Silicate (SiO2:Na2O=from 2:1 to 4:1)
Carbonate Anhydrous sodium carbonate
Citrate Sodium citrate dihydrate
Percarbonate: Sodium percarbonate

### TAED: Tetraacetylethylenediamine

LF224: Non-ionic surfactant available from BASF
DPG: Dipropylene glycol
Neodol 1-9 Non-ionic surfactant available from available from Shell Chemical Company

In the following example all levels are quoted in percent by weight of the composition (either solid or liquid composition).

The composition tabulated below is introduced into a multi-compartment pouch having a first compartment comprising a solid composition (in powder form) and a liquid compartment superposed onto the powder compartment comprising a liquid composition. The pouch is made of Monosol M8630, supplied by Monosol. The weight of the solid composition is 17 grams and the weight of liquid compositions is 2 grams.

| Ingredient | Level (% wt) |
|---|---|
| Solid composition | |
| Silicate | 8 |
| Citrate | 25 |
| Carbonate | 39 |
| Protease PX | 1 |
| Percarbonate* | 18 |
| TAED | 7 |
| LF224 | 1 |
| Processing aids | To balance |
| Liquid composition | |
| DPG | 75 |
| LF224 | 3.5 |
| Neodol 1-9 | 2 |
| Glycerine | 15 |
| Dye | 3 |
| Processing aids | To balance |

15 freshly made pouches as specified herein above are placed in a PE/PET bag. The bag dimensions are 195 mm times 178 mm. The bag is made of a layer of PE (80 μm thick) and a layer of PET (12 μm thick). A small hole is made on the bag to allow any air out, and the top of the bag is heat-sealed. A bag is then placed in a 32° C./80% relative humidity (RH) oven, for 8 weeks. Another bag is placed in the freezer as a fresh reference. After 8 weeks, a bag is taken out of the oven (also freezer samples) and measured for the enzymes remaining in the product. The percentage enzymes retained is calculated as the enzymes remaining in the pouches of the bag taken from the oven divided by the enzymes measured in the pouches of the freezer samples.

### Example 1 (According to the Invention)

The percarbonate in the pouches is sodium percarbonate with a 6% sodium sulphate coating available from Evonik under the name of Q35.

### Example 2 (Comparative)

The percarbonate in the pouches is sodium percarbonate with a 10% sodium sulphate/bicarbonate coating available from Kemira under the name of Ecox 10%

The level of enzyme retention after 8 weeks in the pouches of Example 1 is considerably higher than in the pouches of Example 2. A higher level of retention can also be observed for the bleach activator.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A phosphate-free automatic dishwashing detergent composition comprising:
a) a coated bleach particle comprising a core substantially consisting of bleach and a coating layer enclosing this core and adhering thereto substantially consisting of sodium sulphate; and
b) a protease, amylase or a mixture thereof.
wherein the composition is free of anionic and/or cationic surfactants.

2. A detergent composition according to claim 1 wherein the bleach particle core is produced by fluidised bed spray granulation and the coating layer is obtainable by spraying an aqueous sodium sulphate solution onto the core of the bleach particle in the fluidised bed and by evaporating water while maintaining a fluidised bed temperature of from about 35 to about 100° C.

3. A detergent composition according to claim 1 wherein the coating layer of the bleach particle is from about 5% to about 12% by weight of the particle.

4. A detergent composition according to claim 1 comprising a protease wherein the protease demonstrates at least 90% identity with the wild-type enzyme from Bacillus Lentus, comprising mutations in one or more of the following positions: 68, 87, 99, 101, 103, 104, 118, 128, 129, 130, 167, 170, 194, 205 & 222 and optionally one or more insertions in the region comprising amino acids 95-103.

5. A detergent composition according to claim 1 comprising an amylase wherein the amylase is selected from the group consisting of:
a) an amylase exhibiting at least 95% identity with the wild-type enzyme from Bacillus sp. 707 (SEQ ID NO:7 in U.S. Pat. No. 6,093,562), including those comprising one or more of the following mutations M202, M208, 5255, R172, and/or M261; and
b) an amylase exhibiting at least 95% identity with the wild-type enzyme from AA560 (SEQ ID NO. 12 in WO 06/002643), including those comprising one or more of the following mutations 9, 26, 118, 149, 182, 186, 195, 202, 257, 295, 299, 320, 323, 339, 345 and 458 and optionally comprising one or more deletions at 183 and 184.

6. A detergent composition according to claim 1 further comprising a bleach activator.

7. A detergent composition according claim 1 further comprising a dispersant selected from the group of organic polymers, organic builders and mixtures thereof.

8. A detergent composition according to claim 7 wherein the composition comprises an organic polymer and wherein the organic polymer is a carboxylated polymer.

9. A detergent composition according to claim 7 wherein the composition comprises an organic builder and wherein the organic builder is selected from MGDA, GLDA, IDS carboxymethyl inulin and mixtures thereof.

10. A detergent composition according to claim 1 wherein the detergent composition is in the form of a unit dose product.

11. A detergent composition according to claim 10 wherein the unit dose product comprises at least two compartments one compartment containing a composition in solid form and the other compartment containing a composition in liquid form.

12. A detergent composition according to claim 1 wherein the detergent composition is encompassed in an automatic dishwashing dosing element for use in an auto-dosing device.


SEQUENCE LISTING (3 sequences)

SEQ ID NO: 1 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 2 - protein, 485 aa, Bacillus sp. 707
HHNGTNGTMMQYFEWYLPNDGNHWNRLNSDASNLKSKGITAVWIPPAWKGASQNDVGYGAYDLYDLGEFNQKGTVRTKYGTRSQLQAAVTSLKNNGIQVYGDVVMNHKGGADATEMVRAVEVNPNNRNQEVTGEYTIEAWTRFDFPGRGNTHSSFKWRWYHFDGVDWDQSRRLNNRIYKFRGHGKAWDWEVDTENGNYDYLMYADIDMDHPEVVNELRNWGVWYTNTLGLDGFRIDAVKHIKYSFTRDWINHVRSATGKNMFAVAEFWKNDLGAIENYLQKTNWNHSVFDVPLHYNLYNASKSGGNYDMRNIFNGTVVQRHPSHAVTFVDNHDSQPEEALESFVEEWFKPLAYALTLTREQGYPSVFYGDYYGIPTHGVPAMRSKIDPILEARQKYAYGKQNDYLDHHNIIGWTREGNTAHPNSGLATIMSDGAGGSKWMFVGRNKAGQVWSDITGNRTGTVTINADGWGNFSVNGGSVSIWVNK

SEQ ID NO: 3 - protein, 485 aa, Bacillus sp. AA560
HHNGTNGTMMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVRAVEVNPNNRNQEVSGEYTIEAWTKFDFPGRGNTHSNFKWRWYHFDGVDWDQSRKLNNRIYKFRGDGKGWDWEVDTENGNYDYLMYADIDMDHPEVVNELRNWGVWYTNTLGLDGFRIDAVKHIKYSFTRDWINHVRSATGKNMFAVAEFWKNDLGAIENYLNKTNWNHSVFDVPLHYNLYNASKSGGNYDMRQIFNGTVVQRHPMHAVTFVDNHDSQPEEALESFVEEWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNRAGTVTINADGWGNFSVNGGSVSIWVNK